(19) United States
(12) Patent Application Publication
(10) Pub. No.: US 2025/0198547 A1
(43) Pub. Date: Jun. 19, 2025

(54) TUBE AND METHOD FOR MAKING SAME

(71) Applicant: SAINT-GOBAIN PERFORMANCE PLASTICS CORPORATION, Solon, OH (US)

(72) Inventors: Jiezhu JIN, Westborough, MA (US); Katie CAMPBELL, Northborough, MA (US); Michael J. TZIVANIS, Chicopee, MA (US); Sean DUGAN, Sicklerville, NJ (US); Stephan CHASSEE, Kaarst (DE); Thomas RONG, Aachen (DE); Anne GIERENS, Levallois-Perret (FR); Ashok MOHANTY, Marlborough, MA (US); Josef E. GUESMAN, Uniontown, OH (US)

(21) Appl. No.: 18/980,877

(22) Filed: Dec. 13, 2024

Related U.S. Application Data
(60) Provisional application No. 63/609,527, filed on Dec. 13, 2023.

(51) Int. Cl. F16L 11/12; B29C 48/00; B29C 48/10; B29C 48/21; B29K 27/00; B29K 27/12; B29L 23/00; B32B 1/08; B32B 27/08; B32B 27/30; B32B 27/32; G01D 11/24

(52) U.S. Cl. CPC F16L 11/12; B29C 48/022; B29C 48/10; B29C 48/21; B32B 1/08; B32B 27/08; B32B 27/304; B32B 27/322; G01D 11/245; B29K 2027/12; B29K 2027/16; B29K 2995/0012; B29K 2995/0029; B29K 2995/0031; B29K 2995/0041; B29L 2023/001; B32B 2250/24; B32B 2307/308; B32B 2307/414; B32B 2307/418; B32B 2307/704; B32B 2307/7375; B32B 2597/00

(57) ABSTRACT

A tube including: at least one inner fluoropolymer layer, where the at least one inner fluoropolymer layer includes a first fluoropolymer having a melting temperature of about 140° C. to 200° C., and at least one outer fluoropolymer layer overlying the inner fluoropolymer layer, the at least one outer fluoropolymer layer having an inner surface and an outer surface where the outer fluoropolymer layer includes a second fluoropolymer having a heat shrink temperature of less than 250° C., where the tube has a working temperature up to 180° C., where the at least one outer fluoropolymer layer has a shrink ratio of at least 1.5:1 along the inner surface of the at least one outer fluoropolymer layer.

### CROSS-REFERENCE TO RELATED APPLICATION(S)

This application claims priority under 35 U.S.C. § 119(e) to U.S. Provisional Patent Application No. 63/609,527, entitled “TUBE AND METHOD FOR MAKING SAME,” filed Dec. 13, 2023, by Jiezhu JIN et al., which is assigned to the current assignee hereof and is incorporated herein by reference in its entirety.

### FIELD OF THE DISCLOSURE

This application, in general, relates to a tube and a method for making same, and in particular, relates to a heat shrink tube.

### BACKGROUND

In many industries, sensors are placed in various environments to measure a variety of conditions. An insulating covering may be placed over the sensor to protect the sensors from conditions that could damage the sensor. Typically, a covering is placed over the sensor and heated to “heat shrink” the covering to encapsulate the sensor. Commercially available products used as an insulating covering include low surface energy polymers, such as fluoropolymers. Fluoropolymers exhibit good chemical barrier properties, exhibit a resistance to damage caused by exposure to chemicals, have a resistance to stains, and demonstrate a resistance to damage caused by exposure to environmental conditions. While such low surface energy polymers are desirable due to their chemical resistance, current commercially available products have a high temperature to shrink, such as in excess of 300° C.

Accordingly, in view of the foregoing, there is a continuous need in the industry for improvements in heat shrink tubing that has desirable encapsulation and temperature shrink.

### SUMMARY

In an embodiment, a tube includes at least one inner layer, where the at least one inner layer includes a first fluoropolymer having a melting temperature of about 140° C. to 200° C., and at least one outer layer overlying the inner layer, the at least one outer layer having an inner surface and an outer surface where the outer layer includes a second fluoropolymer having a heat shrink temperature of less than 250° C., where the tube has a working temperature up to 200° C., where the at least one outer layer has a shrink ratio of at least 1.5:1 along the inner surface of the at least one outer layer.

In another embodiment, a method of forming a tube includes providing a first fluoropolymer having a melting temperature of about 140° C. to 200° C.; providing a second fluoropolymer having a heat shrink temperature of less than 250° C.; extruding the first fluoropolymer; and extruding the second fluoropolymer to form a tube including an inner layer including the first fluoropolymer and an outer layer including the second fluoropolymer overlying the inner layer, the at least one outer layer having an inner surface and an outer surface, where the tube has a working temperature up to 180° C., where the at least one outer layer has a shrink ratio of at least 1.5:1 along the inner surface of the at least one outer layer.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary tube according to an embodiment.

FIG. 2 includes a graph of recovery temperature vs. time to close up for a conventional tube and an exemplary tube according to an embodiment.

FIG. 3 includes a graph of duration vs. temperature for a conventional tube, a commodity thermocouple, and an exemplary tube in a dry environment according to an embodiment.

FIG. 4 includes a graph of duration vs. temperature for a conventional tube, a commodity thermocouple, and an exemplary tube in a wet environment according to an embodiment.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . ” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM.

A tube is shown in a number of embodiments. The tube may include at least one inner layer and at least one outer layer overlying the inner layer. In an embodiment, the at least one inner layer includes a first fluoropolymer having a melting temperature of about 140° C. to 200° C. In an embodiment, the at least one outer layer has an inner surface and an outer surface, where the outer layer includes a second fluoropolymer having a heat shrink temperature of less than 250° C. The resulting tube may have a working temperature up to 180° C., where the at least one outer layer has a shrink ratio of at least 1.5:1 along the inner surface of the at least one outer layer. In an embodiment, the tube can encapsulate at least a portion of a sensor to protect at least a portion of the sensor from environmental contaminants and conditions. At least a portion of the sensor may be encapsulated by the tube and the tube can be subjected to a thermal source to heat shrink the tube around the sensor. In an embodiment, “encapsulate” as used herein refers to providing a barrier to a gas, a liquid, a solid, or combination thereof to the portion of the sensor that may be in direct contact with the heat-shrunk tube.

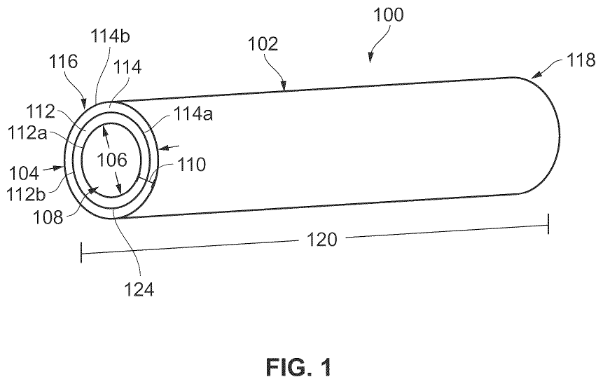

FIG. 1 is a view of a tube 100 according to an embodiment. In a particular embodiment, the tube 100 can include a body 102 having an outer diameter 104 and an inner diameter 106. The inner diameter 106 can form a hollow bore 108 of the body 102. The hollow bore 108 defines a central lumen of the tube. In addition, the body 102 is illustrated as a multilayer tube including an inner layer 112 and an outer layer 114. The inner layer 112 may have an inner surface 112a and an outer surface 112b. The inner surface 112a of the inner layer 112 may define an inner diameter 106 of the tube 100. The outer layer 114 may have an inner surface 114a and an outer surface 114b. The outer surface 114b of the outer layer 114 may define an outer diameter 104 of the tube 100. The outer layer 114 is illustrated as overlying the inner layer 112. The inner layer 112 may be directly in contact with and may directly bond to the outer layer 114 along an inner surface 124 of the outer layer 114. In an example, the outer layer 114 may directly contact the inner layer 112 without intervening adhesive layers, such as a primer. The multilayer tube can include a tube thickness 110 that is measured by the difference between the outer diameter 104 and the inner diameter 106.

Any dimensions of the multilayer tube 100 are envisioned. For instance, any thickness of the layers 112, 114 is envisioned and is typically dependent upon the final properties desired for the multilayer tube 100. In an embodiment, the ratio of the thickness of the inner layer 112 to the outer layer 114 may be 20:1 to 1:20, such as 10:1 to 1:10, such as 5:1 to 1:5, such as 2:1 to 1:2, or even 1:1. It will be appreciated that the ratio of the thickness can be within a range between any of the minimum and maximum values noted above.

According to one embodiment, the tube may be hollow, thin-walled and has a fine geometry, having an inner diameter 106 within a range of about 0.1 mm to about 18.0 mm, such as 0.1 mm to about 15.0 mm, or 0.5 mm to about 15.0 mm. In an embodiment, the outer diameter 104 may be generally within a range of about 0.25 mm to 20.0 mm, such as 1.0 mm to 15.0 mm, or 1.0 mm to 10.0 mm. According to one embodiment, the tube has a uniform thickness 110, within a range of about 0.05 mm to about 3.0 mm, such as 0.1 mm to 1.0 mm, and most often within a range of about of 0.1 mm to 0.75 mm. It will be appreciated that the inner diameter 106, outer diameter 104, and tube thickness 110 can be within a range between any of the minimum and maximum values noted above.

Further, the body 102 can have a length 120, which is a distance between a distal end 118 and a proximal end 116 of the tube 100. In a further embodiment, the length 120 of the body 102 can be at least about 2 centimeters (cm), such as at least about 5 cm, such as at least about 8 cm. The length 120 is generally limited by pragmatic concerns, such as storing and transporting long lengths, or by customer demand.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

As shown in FIG. 1, the tube 100 may include multiple layers. In an embodiment, the inner layer 112 may be the same or different material than the outer layer 114. For instance, the inner layer 112 may include the same or different polymer as the outer layer 114. In an embodiment, the tube 100 includes multiple layers of a fluoropolymer material. For instance, the multilayer tube includes an inner layer 112 including a first fluoropolymer material and an outer layer 114 of a second fluoropolymer material. In an embodiment, the first fluoropolymer material and the second fluoropolymer material may be different materials. In an embodiment, different materials may be used for the first fluoropolymer material and the second fluoropolymer material having the same or different thicknesses. Although illustrated as a two layer tube 100, any number of layers is envisioned. For instance, the tube 100 includes one layer, two layers, three layers, or even a greater number of layers. Irrespective of the number of layers present, the outer diameter and inner diameter of the tube 100 can have any values as defined for the tube 100. The number of layers is dependent upon the final properties desired for the tube 100.

In an embodiment, the tube 100 may further include other layers such as, for example, a polymeric layer, a reinforcing layer, an adhesive layer, a barrier layer, a chemically resistant layer, a metal layer, any combination thereof, and the like. Any reasonable method of providing any additional layer is envisioned and is dependent upon the material chosen. For instance, the additional layer may be an additional polymeric layer of a thermoplastic elastomer that may or may not be extruded. In an embodiment, any number of polymeric layers is envisioned. Any number of layers is also envisioned. In an embodiment, the tube 100 consists essentially of the inner layer 112 and the outer layer 114. As used herein, the phrase “consists essentially of” used in connection with the tube 100 precludes the presence of other layers that affect the basic and novel characteristics of the heat shrink capabilities of the final tube. In an embodiment, the tube 100 consists of the inner layer 112 and the outer layer 114.

According to one embodiment, as stated above, the tube can be comprised of at least one fluoropolymer. An exemplary fluoropolymer may be formed of a homopolymer, copolymer, terpolymer, or polymer blend formed from at least one monomer including fluorine, such as tetrafluoroethylene, hexafluoropropylene, chlorotrifluoroethylene, trifluoroethylene, vinylidene fluoride, vinylidene difluoride, vinyl fluoride, perfluoropropyl vinyl ether, fluorinated ethylene propylene, perfluoromethyl vinyl ether, or any combination thereof. In an embodiment, the fluoropolymer includes a monomer including tetrafluoroethylene, hexafluoropropylene, vinylidene fluoride, or combination thereof. In a particular embodiment, the fluoropolymer includes a poly vinylidene fluoride (PVDF), a terpolymer of tetrafluoroethylene, hexafluoropropylene, and vinylidene difluoride (THV), a fluorinated ethylene propylene (FEP), or combination thereof. Typically, the fluoropolymer includes any nominal fluorine content envisioned. In an embodiment, the nominal fluorine content may be greater than about 60 weight %, such as about 60 weight % to about 80 weight %, or even about 60 weight % to about 70 weight %. It will be appreciated that the nominal fluorine content can be within a range between any of the minimum and maximum values noted above.

In a further embodiment, the fluoropolymer of the tube may include any additive envisioned. The additive may include, for example, a curing agent, an antioxidant, a filler, an ultraviolet (UV) agent, a dye, a pigment, an anti-aging agent, a plasticizer, the like, or combination thereof. In an embodiment, the curing agent may be a cross-linking agent provided to increase and/or enhance crosslinking of the fluoropolymer. In a further embodiment, the use of a curing agent may provide desirable properties such as decreased permeation of small molecules and improved elastic recovery of the material compared to a material that does not include a curing agent. Any curing agent is envisioned such as, for example, a dihydroxy compound, a diamine compound, an organic peroxide, or combination thereof. An exemplary dihydroxy compound includes a bisphenol AF. An exemplary diamine compound includes hexamethylene diamine carbamate. In an embodiment, the curing agent may be an organic peroxide. Any amount of curing agent is envisioned. Any reasonable filler is envisioned. In an embodiment, the filler may improve properties of the tube such as, for example, thermal conductivity, mechanical properties, and the like. Alternatively, the fluoropolymer may be substantially free of crosslinking agents, curing agents, photoinitiators, fillers, plasticizers, or a combination thereof. “Substantially free” as used herein refers to less than about 1.0% by weight, or even less than about 0.1% by weight of the total weight of the fluoropolymer.

Referring still to FIG. 1, in an embodiment, the inner layer 112 may include a first fluoropolymer. The first fluoropolymer may include a poly vinylidene fluoride (PVDF), a terpolymer of tetrafluoroethylene, hexafluoropropylene, vinylidene fluoride (THV), or combination thereof. The first fluoropolymer may include a poly vinylidene fluoride (PVDF). In an embodiment, the inner layer 112 may consist essentially of a first fluoropolymer including or consisting of poly vinylidene fluoride (PVDF), a terpolymer of tetrafluoroethylene, hexafluoropropylene, and vinylidene difluoride, or combination thereof. As used herein, the phrase “consists essentially of” used in connection with the fluoropolymer of a layer precludes the presence of other non-fluorinated monomers and fluorinated monomers that affect the basic and novel characteristics of the fluoropolymer, although, commonly used processing agents and additives such as antioxidants, fillers, UV agents, dyes, pigments, anti-aging agents, and any combination thereof may be used in the fluoropolymer. In an embodiment, the inner layer 112 may consist of a first fluoropolymer including or consisting of poly vinylidene fluoride (PVDF).

In an embodiment, the inner layer 112 may include a first fluoropolymer made from a material having a melting temperature of less than 250° C., such as less than 200° C., less than 180° C., or less than 150° C. In an embodiment, the inner layer 112 may include a first fluoropolymer made from a material having a melting temperature of about 120° C. to about 200° C. It will be appreciated that the melting temperature can be within a range between any of the minimum and maximum values noted above.

Referring still to FIG. 1, in an embodiment, the outer layer 114 can include a second fluoropolymer. In an embodiment, the second fluoropolymer may include fluorinated ethylene propylene (FEP). In an embodiment, the second fluoropolymer can include fluorinated ethylene propylene (FEP) having a crystallinity % of at least 18%, a thermal diffusivity of at least 0.14 mm²/s, and a PPVE monomer content of at least 0.9 wt %. In an embodiment, the outer layer 114 may consist of a second fluoropolymer including or consisting of fluorinated ethylene propylene (FEP). In an embodiment, the outer layer 114 may consist of a second fluoropolymer including or consisting of fluorinated ethylene propylene (FEP).

In an embodiment, the outer layer 114 can include a second fluoropolymer made from a material having a heat shrink temperature of less than 250° C. In an embodiment, the outer layer 114 can include a second fluoropolymer can have a heat shrink temperature of about 160° C. to about 250° C. In comparison, typical commercially available heat shrink tubing have a heat shrink temperature of greater than 300° C. Advantageously and as described, when heat is applied in a range of about 160° C. to about 250° C., the outer surface of the tube 100 (e.g. the outer layer 114) shrinks in a radial direction and squeezes the tube 100 to decrease the overall outer diameter of the tube 100. The heat applied further melts the inner layer 112 such that the fluoropolymer of the inner layer 112 reflows and can encapsulate a component, such as a sensor, while the tube 100 shrinks. It will be appreciated that the heat shrink temperature can be within a range between any of the minimum and maximum values noted above. Further, the temperature applied to heat shrink the outer layer 114 may be a temperature of about 160° C. to 250° C.

In an embodiment, at least one of the first fluoropolymer or the second fluoropolymer (e.g. inner layer or outer layer) can be shrunk. The least one of the first fluoropolymer or the second fluoropolymer of the disclosure has a shrink ratio, defined as the ratio of the shrunk dimension to the unshrunk dimension, of at least about 1:1, such at least about 1.1:1, at least about 1.2:1, at least about 1.3:1, at least about 1.4:1, or at least about 1.5:1. In an example, least one of the first fluoropolymer or the second fluoropolymer may be uniaxially shrunk. Alternatively, least one of the first fluoropolymer or the second fluoropolymer may be biaxially shrunk. In particular, the shrink ratio may be between about 1.5:1 and about 2.5:1, such as about 2:1. It will be appreciated that the shrink ratio can be within a range between any of the minimum and maximum values noted above. In an embodiment the inner surface 114a of the outer layer 114 may exhibit a heat shrink ratio according to any of the range of values above. In an exemplary embodiment, at least one of the first fluoropolymer or the second fluoropolymer is not stretched to a node and fibril structure. In contrast, expanded fluoropolymer is generally biaxially expanded at ratios of about 4:1 to form node and fibril structures. Hence, the heat-shrinkable at least one of the first fluoropolymer or the second fluoropolymer of the disclosure maintains chemical resistance as well as flexibility.

In an embodiment, at least one of the first fluoropolymer or the second fluoropolymer (e.g. inner layer or outer layer) can be expanded. The at least one of the first fluoropolymer or the second fluoropolymer of the disclosure has an expansion ratio, defined as the ratio of the stretched dimension to the unstretched dimension, of not greater than about 4:1, such as not greater than about 3:1, not greater than about 2.5:1, or not greater than about 2:1. In an example, at least one of the first fluoropolymer or the second fluoropolymer may be uniaxially stretched. Alternatively, at least one of the first fluoropolymer or the second fluoropolymer may be biaxially stretched. In particular, the expansion ratio may be between about 1.5:1 and about 2.5:1, such as about 2:1. It will be appreciated that the expansion ratio can be within a range between any of the minimum and maximum values noted above. In an exemplary embodiment, at least one of the first fluoropolymer or the second fluoropolymer is not stretched to a node and fibril structure. In contrast, at least one of the first fluoropolymer or the second fluoropolymer may be generally biaxially expanded at ratios of about 4:1 to form node and fibril structures. Hence, the heat-shrinkable at least one of the first fluoropolymer or the second fluoropolymer of the disclosure maintains chemical resistance as well as flexibility.

In a particular embodiment, at least one of the first fluoropolymer or the second fluoropolymer can be provided by any method envisioned and is dependent upon the fluoropolymer material chosen. In an embodiment, the fluoropolymer material is melt processable. “Melt processable” as used herein refers to a fluoropolymer material that can melt and flow to extrude in any reasonable form such as films, tubes, fibers, molded articles, or sheets. For instance, at least one of the first fluoropolymer or the second fluoropolymer can be a flexible material.

In a particular embodiment, the multilayer tube may be formed by providing the inner layer 112 including the first fluoropolymer as described above. The first fluoropolymer may be provided by any method envisioned and is dependent upon the fluoropolymer chosen for the inner layer 112. In an embodiment, the first fluoropolymer of the inner layer 112 may be extruded, injection molded, or mandrel wrapped. In an exemplary embodiment, the first fluoropolymer of the inner layer 112 may be extruded. In an embodiment, first fluoropolymer of the inner layer 112 may be extruded at a line speed of at least 5 fpm (feet per minute), such as at least 10 fpm, such as at least 20 fpm, or even greater than 50 fpm.

In a particular embodiment, the multilayer tube may be formed by providing the outer layer 114 including the second fluoropolymer as described above. The second fluoropolymer may be provided by any method envisioned and is dependent upon the fluoropolymer chosen for the outer layer 114. In an embodiment, the second fluoropolymer of the outer layer 114 may be extruded, injection molded, or mandrel wrapped. In an exemplary embodiment, second fluoropolymer of the outer layer 114 may be extruded. In an embodiment, second fluoropolymer of the outer layer 114 may be extruded at a line speed of at least 3 fpm (feet per minute), such as at least 4 fpm, such as at least 5 fpm, or even greater than 7 fpm. Further, second fluoropolymer of the outer layer 114 may be cured in place using a variety of curing techniques such as via heat, radiation, or any combination thereof.

In an embodiment, the outer layer 114 may be separately extruded from the inner layer 112 and the inner layer 112 may be positioned within the outer layer 114 after extrusion. In an embodiment, the outer layer 114 may be extruded over the inner layer 112. Further, the layers 112, 114 may be cured using a variety of curing techniques such as via heat, radiation, or any combination thereof. In an embodiment, the inner layer 112 and the outer layer 114 may be coextruded. In an exemplary embodiment, the inner layer 112 may be provided by heating the fluoropolymer to an extrusion viscosity and the outer layer 114 may be provided by heating the fluoropolymer to an extrusion viscosity. When the tube includes multiple layers, any order of extruding the layers together or individually is envisioned.

Advantageously, the inner layer and the outer layer may also be bonded together (e.g. coextruded) at the same time, which may enhance the adhesive strength between the layers. In particular, the inner layer and the outer layer have cohesive strength between the two layers, i.e. cohesive failure occurs wherein the structural integrity of the inner layer and the outer layer fails before the bond between the two layers fails. In a particular embodiment, the adhesive strength between the inner layer and the outer layer is cohesive.

In an embodiment, at least one layer may be treated to improve adhesion between the inner layer and the outer layer. Any treatment is envisioned that increases the adhesion between two adjacent layers. For instance, a surface of the inner layer that is directly adjacent to the outer layer may be treated. Further, a surface of the outer layer that is directly adjacent to the inner layer may be treated. In an embodiment, the treatment may include surface treatment, chemical treatment, sodium etching, use of a primer, or any combination thereof. In an embodiment, the treatment may include corona treatment, UV treatment, electron beam treatment, gamma treatment, flame treatment, scuffing, sodium naphthalene surface treatment, or any combination thereof.

In a particular embodiment, the tube 100 may be provided by any method envisioned. For instance, at least one of the first fluoropolymer or the second fluoropolymer may be provided by any method envisioned and is dependent upon the fluoropolymer chosen for the multilayer tube 100. In an embodiment, at least one of the first fluoropolymer or the second fluoropolymer can be extruded, injection molded, or mandrel wrapped. In an exemplary embodiment, at least one of the first fluoropolymer or the second fluoropolymer can be extruded. Further, at least one of the first fluoropolymer or the second fluoropolymer may be cured in place using a variety of curing techniques such as via heat, radiation, or any combination thereof. Additionally, at least one of the first fluoropolymer or the second fluoropolymer may be expanded (in diameter) by any method envisioned. In particular embodiment, the second fluoropolymer (e.g. outer layer) may be expanded (in diameter) over the first fluoropolymer (e.g. inner layer) by any method envisioned. Additionally, at least one of the first fluoropolymer or the second fluoropolymer may be shrunk (in diameter) by any method envisioned. In particular embodiment, the second fluoropolymer (e.g. outer layer) may be shrunk (in diameter) over the first fluoropolymer (e.g. inner layer) by any method envisioned.

According to a method according to embodiments herein, the outer layer 114 may be expanded according to methods described herein. Next, the inner layer 112 may be positioned within the outer layer 114. Lastly, the combined outer layer 114 and inner layer 112 may be connected via heat shrinking or by another method.

In an embodiment, any post-cure steps may be envisioned. In particular, the post-cure step includes any treatment that may improve or enhance to properties of the tube 100. In an embodiment, the post-cure step includes thermal treatment. Any thermal conditions are envisioned. In an embodiment, neither of first fluoropolymer (e.g. inner layer) or the second fluoropolymer (e.g. outer layer) may be crosslinked.

In an example, the tube 100 may be used to encapsulate at least a portion of a sensor. Once the tube is formed, a sensor is provided within the lumen of the tube 100. Heat is applied to the outer surface to heat shrink the tube around the sensor and melt the material of the inner layer 112. Although a sensor is generally described, any component that needs protection from an environment is envisioned.

In an embodiment, as a result of the method of preparation, the resulting tube 100 may be expanded. The tube 100 of the disclosure has an expansion ratio, defined as the ratio of the stretched dimension to the unstretched dimension, of not greater than about 4:1, such as not greater than about 3:1, not greater than about 2.5:1, or not greater than about 2:1. In particular, the expansion ratio may be between about 1.5:1 and about 2.5:1, such as about 2:1. It will be appreciated that the expansion ratio can be within a range between any of the minimum and maximum values noted above. In an example, the tube 100 may be uniaxially stretched. Alternatively, the tube 100 may be biaxially stretched. In an exemplary embodiment, at least one of the first fluoropolymer or the second fluoropolymer is not stretched to a node and fibril structure. In contrast, tube 100 is generally biaxially expanded at ratios of about 4:1 to form node and fibril structures. Hence, the heat-shrinkable such that at least one of the first fluoropolymer or the second fluoropolymer of the disclosure maintains chemical resistance as well as flexibility.

In an embodiment, as a result of the method of preparation, the resulting tube 100 may be shrunk. The tube 100 of the disclosure has a shrink ratio, defined as the ratio of the shrunk dimension to the unshrunk dimension, of at least about 1:1, such at least about 1.1:1, at least about 1.2:1, at least about 1.3:1, at least about 1.4:1, or at least about 1.5:1. In an example, the tube 100 of the disclosure may be uniaxially shrunk. Alternatively, the tube 100 of the disclosure may be biaxially shrunk. In particular, the shrink ratio may be between about 1.5:1 and about 2.5:1, such as about 2:1. It will be appreciated that the shrink ratio can be within a range between any of the minimum and maximum values noted above.

In an embodiment, as a result of the method of preparation, the resulting tube 100 may have a refractive index of not greater than about 2, such as not greater than about 1.5, not greater than about 1.4, or not greater than about 1. It will be appreciated that the refractive index can be within a range between any of the minimum and maximum values noted above.

In an embodiment, as a result of the method of preparation, the resulting tube 100 may have a light transmission rate of at least 70%, such as at least 75%, at least 80%, or at least 90%. It will be appreciated that the light transmission rate can be within a range between any of the minimum and maximum values noted above.

In an embodiment, as a result of the method of preparation, the resulting tube 100 may have a haze of not greater than 30%, such not greater than 25%, not greater than 21%, or not greater than 15%. It will be appreciated that the haze can be within a range between any of the minimum and maximum values noted above.

Although generally described as a tube, any reasonable polymeric article can be envisioned. The polymeric article may alternatively take the form of a film, a washer, or a fluid conduit. For example, the polymeric article may take the form or a film or a planar article. In another example, the polymeric article may take the form of a conduit, such as tubing. In a particular embodiment, the polymeric article can be used where chemical resistance and/or low permeation to gases and hydrocarbons are desired.

Applications for the tubing are numerous. In an exemplary embodiment, the tubing may be used in applications where sensors and/or electrical components need protection. In an embodiment, the sensor can be a thermocouple, a thermoresistor, and the like. In an embodiment, the tube has advantageous thermal conductivity properties. In another embodiment, the heat-shrink tube can be used to protect an electrical wire connection, a splice, a connector, and the like. For instance, the tube can be used for household wares, industrial, wastewater, digital print equipment, automotive, or other applications where chemical resistance and/or low permeation to gases and hydrocarbons are desired. Further, tubes according to embodiments herein may achieve critical performance in lower heat shrink (less than 250° C.) and sensor encapsulation capabilities up to 180° C., which is currently not available with conventional tubings. Further, tubes according to embodiments herein may achieve better optical performance in clarity versus conventional tubings.

### Examples

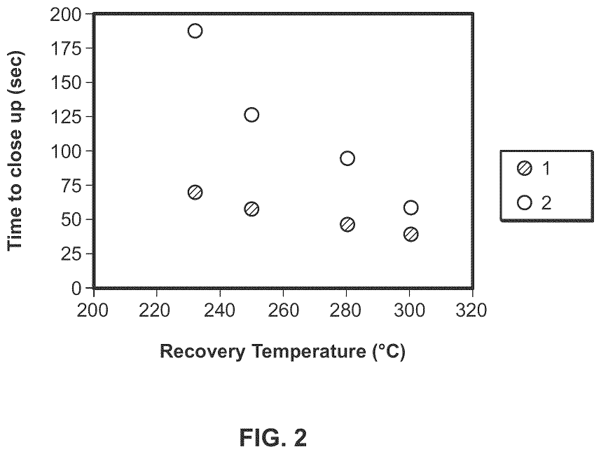

Shrink Time: FIG. 2 includes a graph of recovery temperature vs. time to close up for a conventional tube and an exemplary tube according to an embodiment. A tube according to embodiments herein (1) and a conventional tube (2) were place about a wire, joint, or sensor meant for isolation where the tube has a diameter at least 10% larger than the wire, joint, or sensor. Next, a heat gun, hot air oven, or infrared oven was used to heat the tube. As the tubing heats up, it shrinks and conforms to the shape of the wire, joint, or sensor within it. As shown in FIG. 2, the time to close up is improved critically for tubes according to embodiments herein (1) versus conventional tubes (2) at varying recovery temperatures.

Optical Clarity: Table 1 includes a comparison of haze % and transmission % of a sample jacket for a tube (1), a liner for a tube according to embodiments herein (2), and a conventional liner for a conventional tube (3) as measured using a HunterLab colorimeter. Therefore, a combination of (1) and (2) is in line with tubes according to embodiments herein and a combination of (1) and (3) is in line with conventional tubes. Transmission refers to the percentage of light that passes through a material, while haze measures the scattering of light within the material, affecting its clarity. A high haze value indicates greater light scattering and less clarity, while a lower haze value suggests higher transparency.

TABLE 1

| | Haze, | Standard | Transmission, | Standard |
|---|---|---|---|---|
| Sample | % | deviation | % | deviation |
| A sample jacket for a tube (1) | 4.91 | 0.77 | 94.1 | 0.57 |
| A liner for a tube according | 3.46 | 0.38 | 93.05 | 0.15 |
| to embodiments (2) | | | | |
| A conventional liner for a | 10.13 | 1.45 | 91.09 | 0.66 |
| conventional tube (3) | | | | |

As shown in Table 1, the haze % and transmission % of tubes according to embodiments herein (2) is improved critically versus conventional tubes (3). Further, as shown in Table 1, the haze % and transmission % of tubes according to embodiments herein (1) and (2) is improved critically versus conventional tubes (1) and (3).

Sensor Protection: A bubble test was done to illustrate improved aesthetic performance of a tube according to embodiments herein (1) verse a conventional tube (2). The bubble test included applying heat shrink tubing to splice wires by simply sliding the tubing over the exposed wire section, then applying heat using a heat gun or a heating nozzle to shrink the tubing tightly around the wire, effectively insulating the bare area with the heat applied evenly and for the appropriate amount of time based on the type of heat shrink tubing used. In this procedure, a shrunk temperature of 232° C. was used to shrink the tubing. Next, one end of the tubing is secured with cable ties to silicone tubing, which is sized to tightly fit the needle connected to a nitrogen gas supply line. The nitrogen gas supply line pressure is controlled within the range of 400-600 kPa. Next, a container was filled with silicone oil, ensuring it is large enough to fully submerge the tubing. Next the tubing along with the wire was placed into the pre-heated silicone oil at 180° C., ensuring it is completely submerged. Next, the nitrogen gas supply was activated to allow nitrogen to flow into the silicone tubing and then to the heat shrink tubing sample with a check on the opposite end for any air leaks, which could indicate a seal issue with the tubing. After a 1 minute bubble test duration, the tube according to embodiments herein (1) exhibited a critically improved lack of bubbling (less than 3 bubbles) verse a conventional tube (2) (over 10 bubbles).

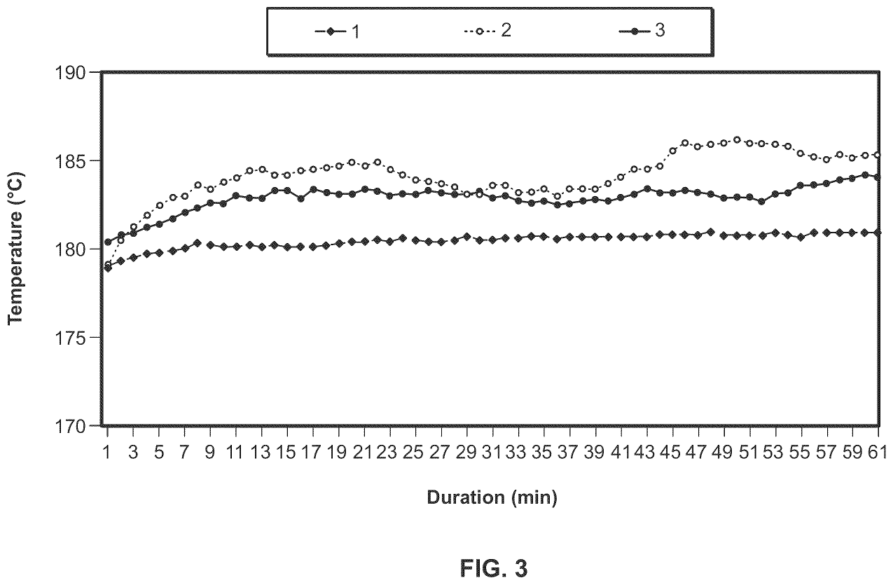

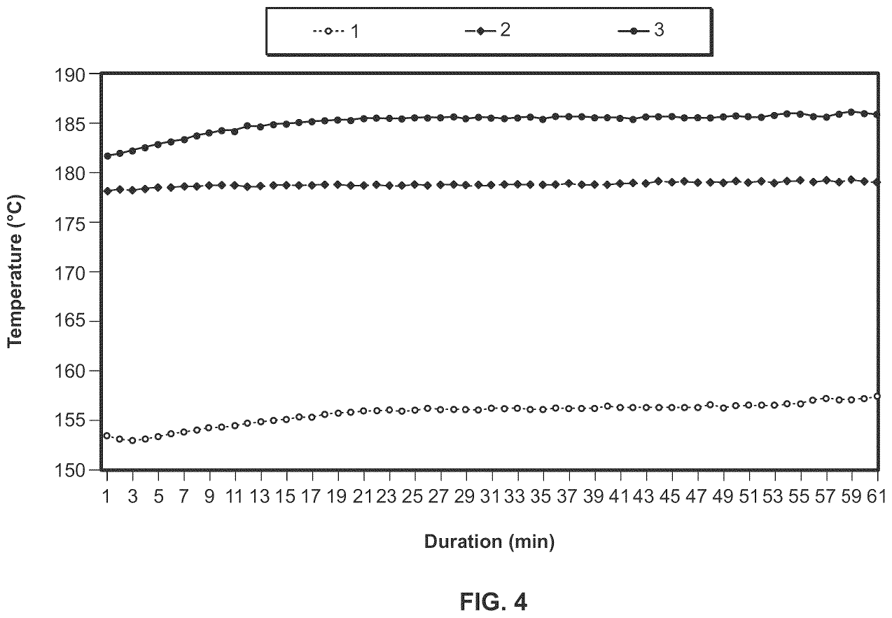

Temperature Sensing: FIG. 3 includes a graph of duration vs. temperature for a conventional tube (2), a commodity thermocouple (3), and an exemplary tube according to embodiments herein (1) in a dry environment according to an embodiment. FIG. 4 includes a graph of duration vs. temperature for a conventional tube (2), a commodity thermocouple (3), and an exemplary tube according to embodiments herein (1) in a wet environment according to an embodiment. The temperature sensing procedure begins by carefully placing temperature sensors inside the oven (dry environment (i.e. FIG. 3)) or silicone oil (wet environment (i.e. FIG. 4)) to monitor the heat distribution during testing. The oven or silicone oil bath was pre-heated to 180° C. Once positioned, the sensors are connected to a data logger or monitoring system to continuously record the temperature readings throughout the process. During the testing, the sensors remain in stable and consistent positions. Our prototype sensors are designed to show the most accurate and stable readings, minimizing any fluctuations or inaccuracies in temperature measurement. The precision and reliability of SG prototype ensures the optimal performance in real-world applications. As shown in FIGS. 3-4, the temperature sensing performance (compared to known temperature of 180° C.) according to embodiments herein (1) is improved critically versus conventional tubes (2), and even versus commodity thermocouples (3).

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1: A tube comprising: at least one inner fluoropolymer layer, wherein the at least one inner fluoropolymer layer comprises a first fluoropolymer having a melting temperature of about 140 to 200° C., and at least one outer fluoropolymer layer overlying the inner fluoropolymer layer, the at least one outer fluoropolymer layer having an inner surface and an outer surface wherein the outer fluoropolymer layer comprises a second fluoropolymer having a heat shrink temperature of less than 250° C., wherein the tube has a working temperature up to 180° C., wherein the at least one outer fluoropolymer layer has a shrink ratio of at least 1.5:1 along the inner surface of the at least one outer fluoropolymer layer.

Embodiment 2: A method of forming a tube comprising: providing a first fluoropolymer having a melting temperature of about 140 to 200° C.; providing a second fluoropolymer having a heat shrink temperature of less than 250° C.; extruding the first fluoropolymer; and extruding the second fluoropolymer to form a tube comprising an inner fluoropolymer layer comprising the first fluoropolymer and an outer fluoropolymer layer comprising the second fluoropolymer overlying the inner fluoropolymer layer, the at least one outer fluoropolymer layer having an inner surface and an outer surface, wherein the tube has a working temperature up to 180° C., wherein the at least one outer fluoropolymer layer has a shrink ratio of at least 1.5:1 along the inner surface of the at least one outer fluoropolymer layer.

Embodiment 3: The tube or the method of forming the tube of any one of the preceding embodiments, wherein the second fluoropolymer comprises fluorinated ethylene propylene (FEP).

Embodiment 4: The tube or the method of forming the tube of any one of the preceding embodiments, wherein the second fluoropolymer comprises fluorinated ethylene propylene (FEP) having a crystallinity % of at least 18%, a thermal diffusivity of at least 0.14 mm²/s, and a PPVE monomer content of at least 0.9 wt %.

Embodiment 5: The tube or the method of forming the tube of any one of the preceding embodiments, wherein the first fluoropolymer comprises a poly vinylidene fluoride (PVDF), Poly(vinylidene fluoride-hexafluoropropylene) (PVDF-HFP), a terpolymer of tetrafluoroethylene, hexafluoropropylene, vinylidene fluoride (THV), or combination thereof.

Embodiment 6: The tube or the method of forming the tube of embodiment 5, wherein the first fluoropolymer comprises poly vinylidene fluoride (PVDF) or Poly(vinylidene fluoride-hexafluoropropylene) (PVDF-HFP).

Embodiment 7: The tube or the method of forming the tube of any one of the preceding embodiments, wherein the tube has a refractive index of not greater than 1.41.

Embodiment 8: The tube or the method of forming the tube of any one of the preceding embodiments, wherein the tube has a light transmission rate of at least 80%.

Embodiment 9: The tube or the method of forming the tube of any one of the preceding embodiments, wherein the tube has a haze of not greater than 21%.

Embodiment 10: The method of forming the tube of any one of embodiments 2 to 8, further comprising: expanding the diameter of the outer fluoropolymer layer.

Embodiment 11: The method of forming the tube of any one of embodiments 2 to 9, further comprising: connecting the inner fluoropolymer layer and the outer fluoropolymer layer such that the outer fluoropolymer layer is positioned over the inner fluoropolymer layer.

Embodiment 12: The method of forming the tube of any one of embodiments 2 to 10, further comprising: shrinking the outer fluoropolymer layer over the inner fluoropolymer layer.

Embodiment 13: The tube or the method of forming the tube of any one of the preceding embodiments, wherein the inner fluoropolymer layer is directly in contact with the outer inner fluoropolymer layer.

Embodiment 14: The tube or the method of forming the tube of any one of the proceeding embodiments, wherein neither of inner fluoropolymer layer or the outer fluoropolymer layer is crosslinked.

Embodiment 15: The tube or the method of forming the tube of any one of the preceding embodiments, wherein the tube has an outside diameter within a range of about 2.4 mm to about 26 mm, such as a range of about 5.0 mm to about 10.0 mm.

Embodiment 16: The tube or the method of forming the tube of any one of the preceding embodiments, wherein the tube has an inner diameter within a range of about 1.4 mm to about 22.0 mm.

Embodiment 17: The tube or the method of forming the tube of any one of the preceding embodiments, wherein the tube encapsulates a sensor.

Embodiment 18: The method of forming the tube of any one of embodiments 2 to 17, wherein extruding the first fluoropolymer comprises a line speed of at least 5.0 fpm (feet per minute).

Embodiment 19: The method of forming the tube of any one of embodiments 2 to 18, wherein extruding the second fluoropolymer comprises a line speed of at least 3.0 fpm (feet per minute).

Embodiment 20: A method of forming the tube of any one of embodiments 2 to 19, further comprising: providing a sensor within the tube; and applying heat to the outer surface to heat shrink the tube around the sensor.

Embodiment 21: The method of forming the tube of embodiment 20, wherein the heat applied to heat shrink the outer surface is a temperature of about 160° C. to 250° C.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A tube comprising:
at least one inner fluoropolymer layer, wherein the at least one inner fluoropolymer layer comprises a first fluoropolymer having a melting temperature of about 140° C. to 200° C., and
at least one outer fluoropolymer layer overlying the inner fluoropolymer layer, the at least one outer fluoropolymer layer having an inner surface and an outer surface wherein the outer fluoropolymer layer comprises a second fluoropolymer having a heat shrink temperature of less than 250° C., wherein the tube has a working temperature up to 180° C., wherein the at least one outer fluoropolymer layer has a shrink ratio of at least 1.5:1 along the inner surface of the at least one outer fluoropolymer layer.

2. A method of forming a tube comprising:
providing a first fluoropolymer having a melting temperature of about 140° C. to 200° C.;
providing a second fluoropolymer having a heat shrink temperature of less than 250° C.;
extruding the first fluoropolymer; and
extruding the second fluoropolymer to form a tube comprising an inner fluoropolymer layer comprising the first fluoropolymer and an outer fluoropolymer layer comprising the second fluoropolymer overlying the inner fluoropolymer layer, the at least one outer fluoropolymer layer having an inner surface and an outer surface, wherein the tube has a working temperature up to 180° C., wherein the at least one outer fluoropolymer layer has a shrink ratio of at least 1.5:1 along the inner surface of the at least one outer fluoropolymer layer.

3. The tube of claim 1, wherein the second fluoropolymer comprises fluorinated ethylene propylene (FEP).

4. The tube of claim 1, wherein the second fluoropolymer comprises fluorinated ethylene propylene (FEP) having a crystallinity % of at least 18%, a thermal diffusivity of at least 0.14 mm²/s, and a PPVE monomer content of at least 0.9 wt %.

5. The tube of claim 1, wherein the first fluoropolymer comprises a poly vinylidene fluoride (PVDF), Poly(vinylidene fluoride-hexafluoropropylene) (PVDF-HFP), a terpolymer of tetrafluoroethylene, hexafluoropropylene, vinylidene fluoride (THV), or combination thereof.

6. The tube of claim 5, wherein the first fluoropolymer comprises poly vinylidene fluoride (PVDF) or Poly(vinylidene fluoride-hexafluoropropylene) (PVDF-HFP).

7. The tube of claim 1, wherein the tube has a refractive index of not greater than 1.41.

8. The tube of claim 1, wherein the tube has a light transmission rate of at least 80%.

9. The tube of claim 1, wherein the tube has a haze of not greater than 21%.

10. The method of forming the tube of claim 2, further comprising: expanding the diameter of the outer fluoropolymer layer.

11. The method of forming the tube of claim 2, further comprising: connecting the inner fluoropolymer layer and the outer fluoropolymer layer such that the outer fluoropolymer layer is positioned over the inner fluoropolymer layer.

12. The method of forming the tube of claim 2, further comprising: shrinking the outer fluoropolymer layer over the inner fluoropolymer layer.

13. The tube of claim 1, wherein the inner fluoropolymer layer is directly in contact with the outer inner fluoropolymer layer.

14. The tube of claim 1, wherein neither the inner fluoropolymer layer or the outer fluoropolymer layer is crosslinked.

15. The tube of claim 1, wherein the tube has an outside diameter within a range of about 2.4 mm to about 26 mm, such as a range of about 5.0 mm to about 10.0 mm.

16. The tube of claim 1, wherein the tube has an inner diameter within a range of about 1.4 mm to about 22.0 mm.

17. The tube of claim 1, wherein the tube encapsulates a sensor.

18. The method of forming the tube of claim 2, wherein extruding the second fluoropolymer comprises a line speed of at least 3.0 fpm (feet per minute).

19. A method of forming the tube of claim 2, further comprising:
providing a sensor within the tube; and
applying heat to the outer surface to heat shrink the tube around the sensor.

20. The method of forming the tube of claim 19, wherein the heat applied to heat shrink the outer surface is a temperature of about 160° C. to 250° C.
